(19) United States
(12) Patent Application Publication
(10) Pub. No.: US 2006/0230186 A1
(43) Pub. Date: Oct. 12, 2006

(54) Method of resetting a plurality of connected units

(76) Inventor: Pedro Lucas, Amadora (PT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/568,118

(22) PCT Filed: Aug. 5, 2004
(86) PCT No.: PCT/EP04/08841

§ 371 Date: Feb. 13, 2006

(30) Foreign Application Priority Data
Aug. 14, 2003 (GB) 0319014.7

(51) Int. Cl. G06F 15/16

(52) U.S. Cl. 709/251

(57) ABSTRACT

A method of resetting a plurality of connected nodes comprising initiating a reset request at a first node; sending a packet from said first node to a second node wherein said packet is recognised by said second node as a reset command, and said second node resets itself. Usually the reset request packet is send serially and sequentially to further nodes. The nodes may be arranged in a ring.

### CROSS REFERENCE TO RELATED APPLICATION

This application is the US National Stage of International Application No. PCT/EP2004/008841, filed Aug. 5, 2004 and claims the benefit thereof. The International Application claims the benefits of British Patent application No. 0319014.7 GB filed Aug. 14, 2003, both of the applications are incorporated by reference herein in their entirety:

### FIELD OF THE INVENTION

The invention relates to a method of resetting connected units and has particular but not exclusive application to packet rings having a large number of units (nodes).

### BACKGROUND OF THE INVENTION

Units or nodes as they are referred to in the remainder of the description can be computers or hardware devices. They are usually remotely connected by communication lines such as optical fibres, and carry e.g. data in frames or packets. The term “node” however generally refers to any computing or telecommunication device. And include units such as modules of devices circuit boards which may be plugged in a shelf or rack. A typical node comprises a processor, memory and interface.

The invention relates to re-setting nodes which are connected with each other. The term “re-setting” includes power on, power off, e.g. by unplugging the node board from the shelf from the shelf and plugging it back in, or e.g. re-setting registers, etc.

Up until now nodes have been reset by physically pulling out and plugging in nodes. Although this is cheap it is very time consuming as well as degrades material. Further more this is not feasible if the nodes are distant. Using robots is expensive. Slow and requires additional maintenance programming synchronisation etc. A further alternative of using electrical devices connected to each node means building devices for all the nodes, the device must be external, by its implementation the node (e.g. board) must not be affected, If the node boards have a different implementation there must be distinct devices.

The use of a management command to reset each node has the problem that it requires all notes to be reachable by the management and the insertion of additional nodes requires management awareness; it is also dependent on the management implementation; different node types versions require different management. Decreasing the feasibility of this solution.

### SUMMARY OF THE INVENTION

The invention comprises a method of resetting a plurality of connected nodes comprising initiating a reset request at a first node; sending a packet from said first node to a second node wherein said packet is recognised by said second node as a reset command, and said second node resets itself.

The reset request packet is then normally send serially and sequentially to further nodes. The nodes may be arranged in a ring, straightforward chain, branched chain or tree structure.

Where they are arranged in a ring, the reset packet preferably has a register which is decremented on passing through a node

A time delay is advantageously set up at a node once a reset packet is received in order for the packet to be further processed and sent on before resetting is implemented.

### BRIEF DESCRIPTION OF THE DRAWING

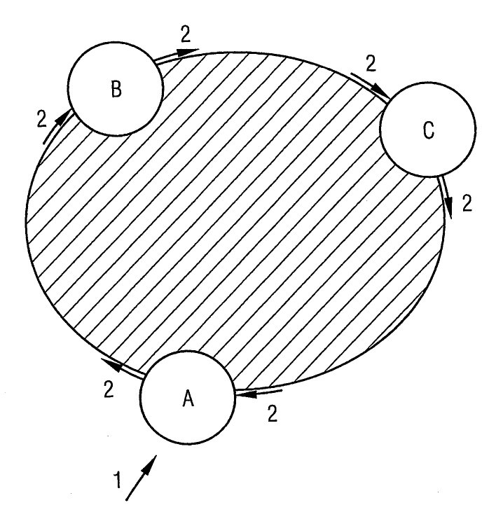

The invention will now be described by means of example and to FIG. 1, which shows an example of a system to which the invention can be applied.

### DETAILED DESCRIPTION OF THE INVENTION

FIG. 1 shows a ring of three 3 nodes, connected through a unidirectional connection. At node A, a reset request 1 is made. This may be made through e.g. a data plane interface, debug interface or management interface. Node A detects the reset request and triggers a delay T and sends a data packet 2 on to node B. This data packet is a reset request data packet which is recognisable as such and includes a TTL (Time To Live) value. This is set to the number of nodes −1, after it leaves the first node. In the example the TTL as it leave node A is thus 2. After the reset packet is sent, node A resets itself. At node B the packet is detected a reset request, remove the packet and triggers a delay T. The TTL is decremented by one (−1). When the packet is received by Node C the processing is the same as at node B. The packet is sent to Node A where the TTL is zero. At this point node A discards the packet.

The time delay T is used so that time is allowed for the node to process and dispatch the packet before it is reset. The delay should be of reasonable length so that the packet can be sent forward before the reset is activated, and thus is preferably at least equal to: the time to amend/build the reset packet for next transmission; plus the time in the output queue, plus the time for reset packet transmission.

Alternatively a flag may be set which indicates that the reset packet has been forwarded (i.e. left the node) and only then does the node reset itself. The time delay is preferred as the processing portion that triggers the reset can be made more independent of that portion responsible for packet transmission. That is to say the option of using a flag to indicate the packet has been sent requires more interaction between the functional components.

Each node thus contains some software which implements the reset by recognising and initiating the request acting upon it and passing the reset packet on i.e. detection processing and transit of the packet. The reset packet is essentially a control packet. The reset packet is characterised (e.g. formatted/coded) so as to be recognised as such.

The TTL decrement register (option) is a preferred method to discard packets which are going nowhere or whose function has been performed. The node software would include code to decrement and where appropriate, discard the packet.

In a straightforward implementation the reset command is implemented by sending a specific data packet to a node external interface.

In a preferred embodiments the invention makes use of standard interfaces, e.g. the debugging interface. All communication devices include a console (commonly a RS232 serial interface) for troubleshooting. These interfaces are advantageously used to initiate the command to reset all nodes. The first node then assembles the reset packet. This command would commonly be processed by a common parser, and the skilled man would appreciate the many ways this could be implemented. In another embodiment the reset command is initiated by a node/shelf manager request. The node recognises this and assembles the reset packet. This is preferred as if a data packet is used instead to initiate the reset procedure, there is always a possibility, if the functionality is enabled to customer, that a hacker may send such data packets and keep resetting the nodes. If instead, a manager request or the debug interface is used, this problem is solved.

1-9. (canceled)

10. A method of resetting a plurality of connected nodes, comprising:
initiating a reset request at a first node; and
sending a reset request packet from the first node to a second node,
wherein the reset request packet is recognized by the second node as a reset command, and the second node resets itself.

11. The method of resetting a plurality of connected nodes as claimed in claim 10, wherein the reset request packet is sent serially and sequentially to further nodes.

12. The method of resetting a plurality of connected nodes as claimed in claim 10, wherein the nodes are arranged in a ring.

13. The method of resetting a plurality of connected nodes as claimed in claim 10, wherein the reset packet has a register that is decremented on passing through a node.

14. The method of resetting a plurality of connected nodes as claimed in claim 10, wherein when a node receives and recognizes a reset packet, a time delay is started for the packet to be further processed and sent on before resetting is implemented.

15. The method of resetting a plurality of connected nodes as claimed in claim 10, wherein a standard interface is used to initiate the reset re-set packet.

16. The method of resetting a plurality of connected nodes as claimed in claim 10, wherein the method is initiated by a manager request that is converted into a control reset packet.

17. The method of resetting a plurality of connected nodes as claimed in claim 10, wherein the method is initiated by a debug command that is converted into a control reset packet.

18. The method of resetting a plurality of connected nodes as claimed in claim 10, wherein the node is a node in a computing or telecommunications network and is able receive a reset data packet and to recognize the packet and reset the node and able to forward the reset data packet to other nodes.
